(19) United States
(12) Patent Application Publication
(10) Pub. No.: US 2016/0034121 A1
(43) Pub. Date: Feb. 4, 2016

(54) Method and Apparatus for Automatically Displaying Multiple Presentations for Multiple Users

(71) Applicant: Wal-Mart Stores, Inc., Bentonville, AR (US)

(72) Inventors: Donald R. High, Noel, MO (US); Mike Atchley, Springdale, AR (US); Luke Lowery, Bella Vista, AR (US); Ian N. Brown, Rogers, AR (US)

(21) Appl. No.: 14/812,428

(22) Filed: Jul. 29, 2015

Related U.S. Application Data
(60) Provisional application No. 62/030,952, filed on Jul. 30, 2014.

(51) Int. Cl. G06F 3/0484; G06F 3/0481

(52) U.S. Cl. CPC G06F 3/0484; G06F 3/0481

(57) ABSTRACT

A control circuit identifies users within a presentation zone that includes a plurality of displays. The control circuit then automatically selects at least two particular presentations from amongst a plurality of available presentations. By one approach one of the selected presentations corresponds to one of the identified users while another of the selected presentations corresponds to another of the identified users. The control circuit then automatically presents, at least substantially simultaneously, the selected presentations using the plurality of displays in the presentation zone.

### RELATED APPLICATION(S)

This application claims the benefit of U.S. Provisional application No. 62/030,952, filed Jul. 30, 2014, which is incorporated by reference in its entirety herein.

### TECHNICAL FIELD

These teachings relate generally to the presentation of computer-based visualizations.

### BACKGROUND

Data mining is known in the art and, generally speaking, pertains to discovering patterns in large data sets. Such processing often includes extracting information from a data set and transforming that information into an understandable structure for further use. Such practices often involve database and data management aspects, data preparation, aggregation of values, the execution of statistical models and/or inference considerations, interestingness metrics, complexity considerations, post-processing of discovered structures, and the development of corresponding visualizations.

Notwithstanding the potent capabilities of computers to facilitate such activities, in many cases such automated “number crunching” serves only as a predicate or counterpart to human analysis and insight. Human-based analysis, in turn, often benefits from repeated interactions with a given presentation of information (such as one or more visualizations as corresponds to execution of a statistical analysis of interest). Unfortunately, human cognition is sometimes too easily interrupted. As but one simple example in these regards, the logistics of the human-machine interface can be sufficiently nonintuitive and/or complex as to unduly disrupt the user's train of thought.

Some amount of automation, including customized automation, may help ameliorate such requirements and concerns. Unfortunately, supporting such design considerations can be costly (both in terms of the initial design and capital outlay and in terms of ongoing support and maintenance). Such cost considerations, in turn, can render the visualization and analysis infrastructure a scarce commodity in a given enterprise and thereby ultimately deprive the enterprise of more widespread usage of such infrastructure and the resultant analytical benefits that one might expect.

### BRIEF DESCRIPTION OF THE DRAWINGS

The above needs are at least partially met through provision of the method and apparatus for automatically presenting multiple presentations for multiple users described in the following detailed description, particularly when studied in conjunction with the drawings, wherein:

FIG. 1 comprises a flow diagram as configured in accordance with various embodiments of these teachings;

FIG. 2 comprises a block diagram as configured in accordance with various embodiments of these teachings;

FIG. 3 comprises a schematic representation as configured in accordance with various embodiments of these teachings;

FIG. 4 comprises a schematic representation as configured in accordance with various embodiments of these teachings;

FIG. 5 comprises a schematic representation as configured in accordance with various embodiments of these teachings;

FIG. 6 comprises a schematic representation as configured in accordance with various embodiments of these teachings;

FIG. 7 comprises a schematic representation as configured in accordance with various embodiments of the invention;

FIG. 8 comprises a schematic representation as configured in accordance with various embodiments of these teachings;

FIG. 9 comprises a schematic representation as configured in accordance with various embodiments of the invention; and

FIG. 10 comprises a schematic representation as configured in accordance with various embodiments of these teachings

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a control circuit identifies users within a presentation zone that includes a plurality of displays. The control circuit then automatically selects at least two particular presentations from amongst a plurality of available presentations. By one approach one of the selected presentations corresponds to one of the identified users while another of the selected presentations corresponds to another of the identified users. The control circuit then automatically presents, at least substantially simultaneously, the selected presentations using the plurality of displays in the presentation zone.

These teachings are highly flexible in practice and will accommodate a variety of modifications and/or embellishments to the foregoing. By one approach, for example, the control circuit conducts the foregoing activities as the users enter the presentation zone in seriatim fashion over time. In that case, the control circuit may automatically present a first presentation as corresponds to a user who first entered the presentation zone and then later automatically present a second presentation as corresponds to a second user who later entered the presentation zone, such that the rendering of the two presentations overlap partially in time in correspondence to the overlapping presence of the two users in the presentation zone during a same period of time.

By one approach the control circuit also automatically halts the display of a given presentation in response to any of a variety of triggering events. For example, the control circuit may detect that the user who corresponds to the given presentation has left the presentation area. As another example, the control circuit may detect that another user has entered the presentation area who lacks sufficient authorization to view the given presentation.

So configured, a well-equipped presentation zone will readily simultaneously support, in a highly intuitive manner, the presence of multiple users who seek to employ those resources for different purposes. By greatly simplifying user requirements in this manner, user frustration can be greatly mitigated and overall usage of the system increased.

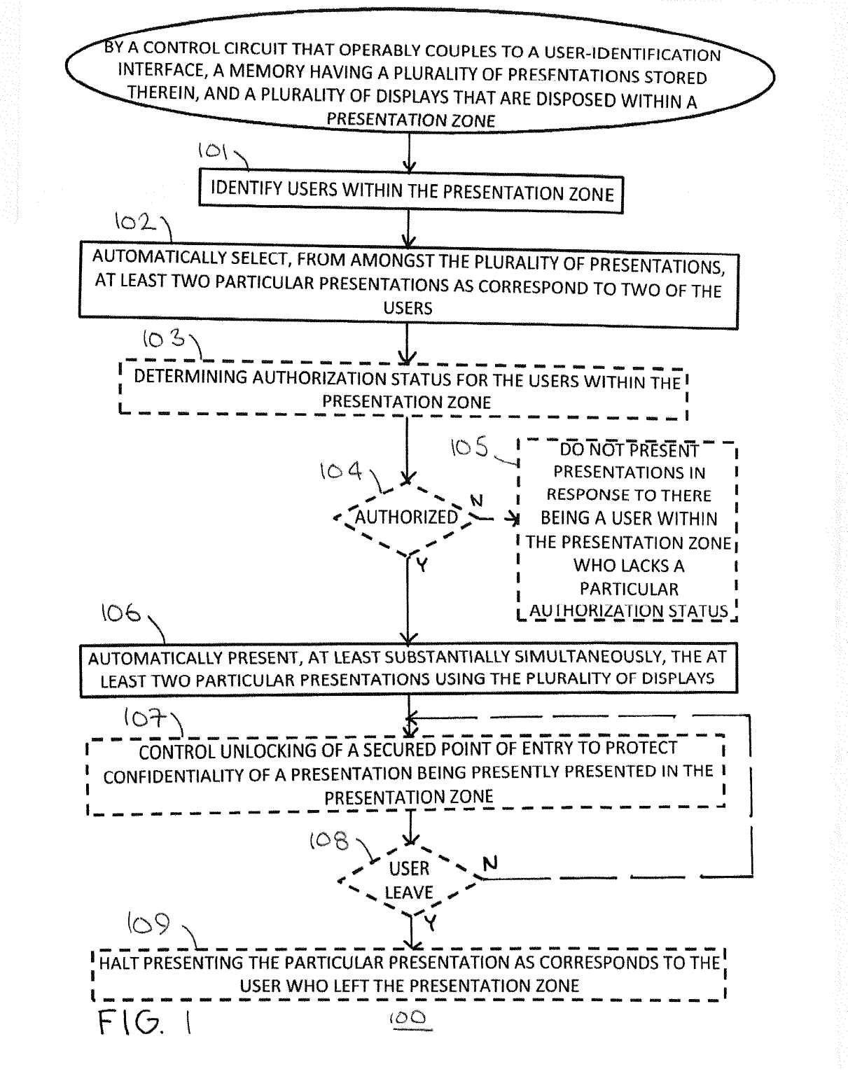

These and other benefits may become clearer upon making a thorough review and study of the following detailed description. Referring now to the drawings, and in particular to FIG. 1, an illustrative process 100 that is compatible with many of these teachings will now be presented.

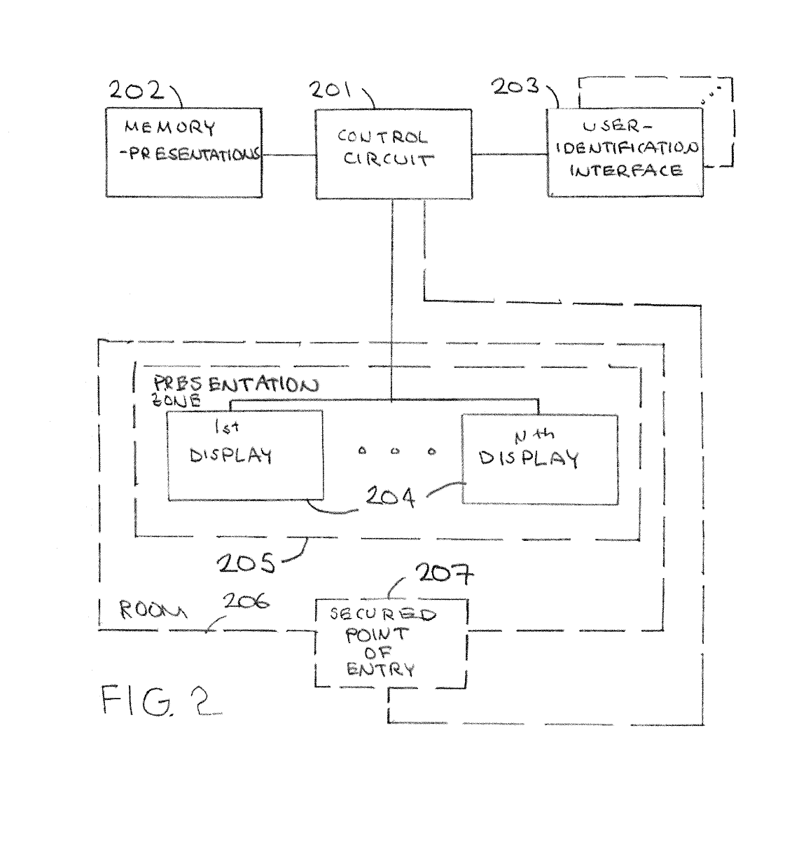

With momentary reference to FIG. 2, for the sake of an illustrative example it will be presumed here that a control circuit 201 carries out this process 100. Such a control circuit 201 can comprise a fixed-purpose hard-wired platform or can comprise a partially or wholly programmable platform. These architectural options are well known and understood in the art and require no further description here. This control circuit 201 is configured (for example, by using corresponding programming as will be well understood by those skilled in the art) to carry out one or more of the steps, actions, and/or functions described herein.

In this illustrative example the enabling system 200 also includes a memory 202, one or more user-identification interfaces 203, and one or more displays 204 that all operably couple to the control circuit 201. The memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

This memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the memory 202 also serves to store at least one presentation. Generally speaking, for many application settings this presentation will comprise at least one executable statistical analysis. By one approach the executable statistical analysis represents a retail sales enterprise (including, for example, one or more publicly-accessible retail sales stores, one or more distribution centers and warehouses, and/or one or more transportation fleets by which goods are moved from and between manufacturers, distribution centers/warehouses, and retail sales stores). In a typical application setting the executable statistical analysis, when executed, provides at least one analytical result as a function of numerous variables. Example analytical results can include, but are certainly not limited to, sales figures, costs, gross and net income, pricing, and so forth. Such executable statistical analyses are known in the art. As the present teachings are not particularly sensitive to any specific choices in these regards, further elaboration will not be provided here regarding executable statistical analyses.

The user-identification interface 203 can comprise any of a variety of mechanisms and methodologies as are known in the art. By one approach the user-identification interface 203 can comprise a badge/card reader that reads an identification code that uniquely identifies the person to whom the badge/card is assigned. Examples in these regards include badges/cards that can be read using optical scanning techniques, radio-frequency identification tag reading techniques, and so forth. Other options are also available. As one example each person can be required to enter a code (such as an alphabetic, numeric, or alphanumeric code) that uniquely identifies them via a keypad. As another example, the user-identification interface can detect one or more biometrics that can uniquely identify an individual person. Examples in these regards include but are not limited to fingerprint scanners, palm-print scanners, retinal scanners, face-recognition systems, voice-recognition systems, and so forth.

The aforementioned displays 204 can comprise, for example, any of a variety of flat-screen displays as are known in the art as well as front and rear projection systems. By one approach these displays can comprise touch-screen displays and hence can receive user input via contact with the screen. The number and size of the displays can vary with the needs of the application setting. As one illustrative example in these regards, the control circuit 201 may operably couple to five large flat screen displays that are all more-or-less horizontally aligned in a shared presentation zone 205 that is enclosed, for example, within a secured room 206. Various display technologies are known in the art and the present teachings are not particularly sensitive to any particular selections in these regards. Accordingly, and again, further elaboration will not be provided here for the sake of brevity.

The aforementioned secured room 206 may, for example, be windowless and may have a secured point of entry 207. By one approach the control circuit 201 operably couples to the secured point of entry 207 and hence can control, for example, the locked/unlocked state of that secured point of entry 207. This secured room 206 in general and the presentation zone 205 in particular may have such items of furniture, illumination, and/or decoration as may be desired.

Referring again to FIG. 1, at block 101 the control circuit 201 identifies users within the presentation zone 205 via the user-identification interface 203. By one approach this identification occurs (or at least begins) before the user enters the presentation zone 205. For example, when the user-identification interface 203 comprises a badge reader located outside the aforementioned room 206 (proximal, for example, to the secured point of entry 207), the control circuit 201 may be pre-informed as to the identity of users upon being granted admission to the room 206 and hence the presentation zone 205.

The foregoing activity presumes that authorized users are already entered into the system. Accordingly, particular users are pre-associated with their corresponding identification information as used by the user-identification interface 203. By one approach these teachings also provide for associating one or more presentations with specific corresponding users. For example, a visualization for a first executable statistical analysis may be associated with a first executive of a retail enterprise while another visualization for a different executable statistical analysis may be associated with a second, different executive of that same retail enterprise.

At block 102, the control circuit 201 uses the previously-gleaned information regarding the identity of the user to automatically select, from amongst a plurality of such presentations, a particular presentation as corresponds to the identified user. In particular, when there are a plurality of users within the presentation zone, this block 102 will accommodate selecting multiple presentations as correspond to a plurality of those users. As a simple illustrative example in these regards, when the aforementioned first and second executive are both present, the control circuit can automatically select both the aforementioned visualization for the first executable statistical analysis and the visualization for the second executable statistical analysis.

Before presenting these selected presentations, if desired and as shown at optional block 103, the control circuit 201 can determine the authorization status for the users within the presentation zone 205. At optional decision block 104, the control circuit 201 can then automatically determine whether all of the users within the presentation zone 205 have sufficient authorization for all of the selected presentations. When such is not the case, at block 105 the control circuit 201 can automatically determine to not present at least one of the selected presentations in response to there being a user within the presentation zone 205 who lacks the requisite authorization status.

When all users present have the appropriate authorization status (or when the activities set forth at optional blocks 103-105 are not implemented), at block 106 the control circuit 201 now automatically presents, at least substantially simultaneously, the selected presentations using the plurality of displays 204. As used herein, it will be understood that this reference to being “substantially simultaneously” does not require that the two presentations begin and end at exactly the same moments. Instead, it will be sufficient if the viewing of these two presentations temporally overlap in any way.

So configured, more than one user can have the benefit of accessing, studying, and otherwise interacting with presentations of interest to them while sharing the resources of such a presentation zone with one or more other users who are accessing their own content of interest. These teachings are highly flexible in practice and will accommodate various ways of leveraging such capabilities. As one simple example in these regards, when only a first user occupies the presentation zone 205, the control circuit 201 may employ all of the available displays 204 when rendering that user's selected presentation. When a second user enters the presentation zone 205, the control circuit 201 may reassign the first user's presentation to only two of the available displays 204 while then using the remaining displays 204 to render the selected presentation for the second user.

As noted above the control circuit 201 can leverage its knowledge regarding the users and their authorization status to prohibit initiating the display of a particular presentation when an unauthorized user is present. At optional block 107 the control circuit 201 can leverage such information in a different way. In particular, the control circuit 201 can control the unlocking of the aforementioned secured point of entry 207 to thereby protect the confidentiality of a presentation presently being shown in the presentation zone 205. For example, when a person presents their badge at the secured point of entry 207, the control circuit 201 can maintain the secured point of entry 207 in a locked status to prevent that person from entering the room 206 and gaining access to the presentation zone 205 when they lack the requisite authorization status.

As another example in these regards, at optional blocks 108 and 109 the control circuit 201 can leverage the user-identification interface 203 to detect when a user leaves the presentation zone 205 and/or the room 206 and responsively halt presentation of the presentation that corresponds to that user. By one approach the control circuit 201 blanks the corresponding display 204 or otherwise presents innocuous non-confidential content on that display 204 when so halting the presentation. By another approach the control circuit 201 simply freezes the presentation for the moment.

To further help exemplify the capabilities and leveragability of the foregoing teachings, a number of illustrative examples will now be described. It will be understood that no particular limitations with respect to the scope of these teachings are intended by way of the specifics of these examples.

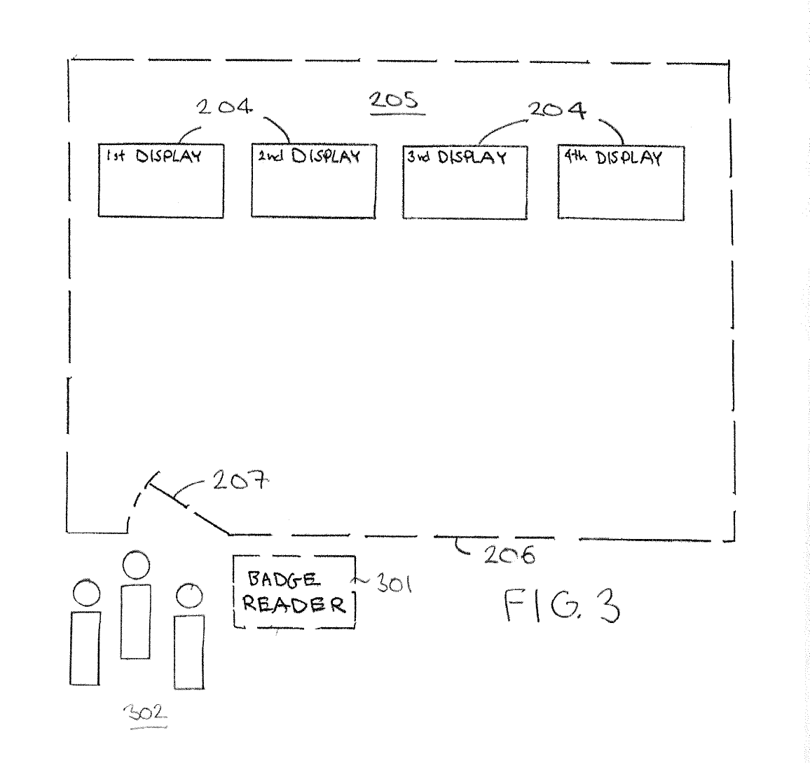

Referring to FIG. 3, in this example the presentation zone 205 includes four displays 204. A secured room 206 encloses the presentation zone 205. A secured point of entry 207 provides the only point of ingress and egress to the room 206. A badge reader 301 located at the secured point of entry 207 serves as the aforementioned user-identification interface 203.

In this example a first group of executives 302 present their respective badges to the badge reader 301. Their identities and authorization status thereby determined, the control circuit 201 unlocks the secured point of entry 207 to permit this first group of executives 302 to enter the room 206 and gain access to the presentation zone 205.

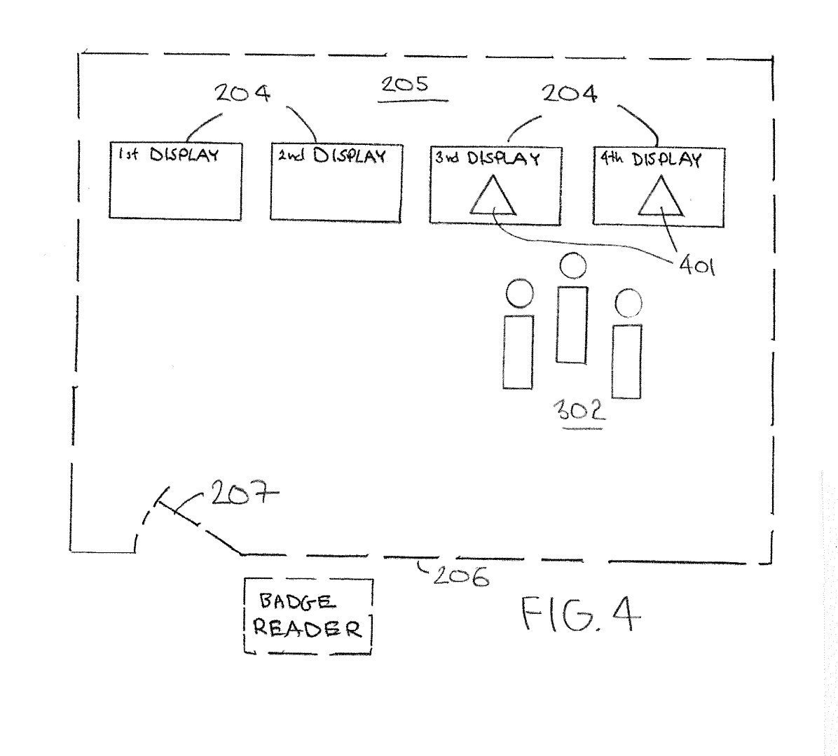

Referring to FIG. 4, the control circuit 201 identifies the hierarchically most-senior executive in this first group of executives 302. Per the foregoing teachings the control circuit 201 then identifies a particular presentation 401 as corresponds to this most-senior executive and automatically begins presenting that content on the third and fourth displays 204. The members of this first group of executives 302 are then able to view, consider, study, and interact with that particular presentation 401. By one approach the control circuit 201 may select the displays to be used without regard for the identity of the user. By another approach the user may have a profile on record by which preferences in these regards can be stored and referred to such that their presentations appear on preferred displays (at least one available).

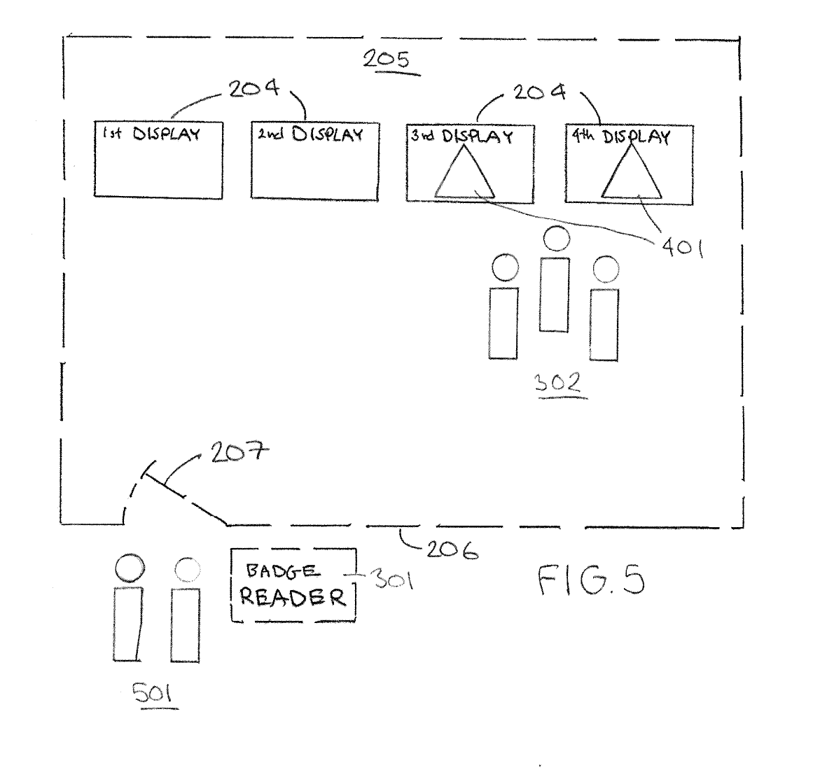

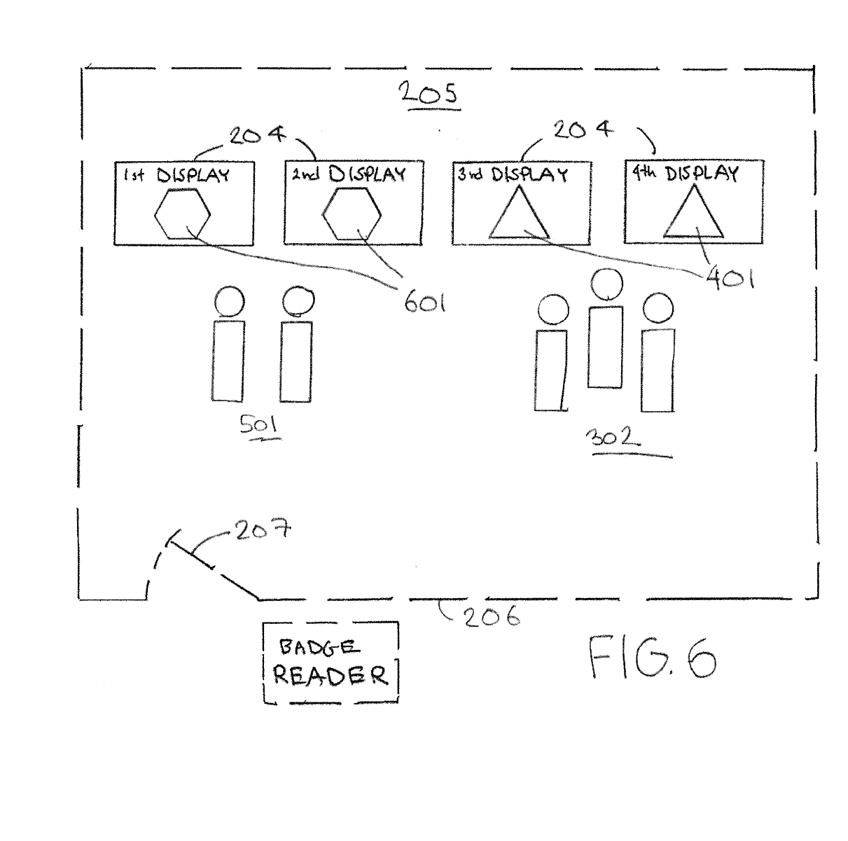

Referring now to FIG. 5, a second group of executives 501 now approach the secured point of entry 207 and present their badges to the badge reader 301. The control circuit 201 again uses this information to identify the users and to determine their respective levels of authorization. Referring to FIG. 6, the control circuit 201 uses the information for at least one of the executives in the second group of executives 501 to automatically select another presentation 601 which the control circuit 201 automatically presents using the first and second displays 204 in the presentation zone 205. So configured, both groups of executives 302 and 501 are able to gain access to the resources of the presentation zone 205 and their own previously-determined content of interest without requiring any particular information technology skills or training and without distractions or inconveniences.

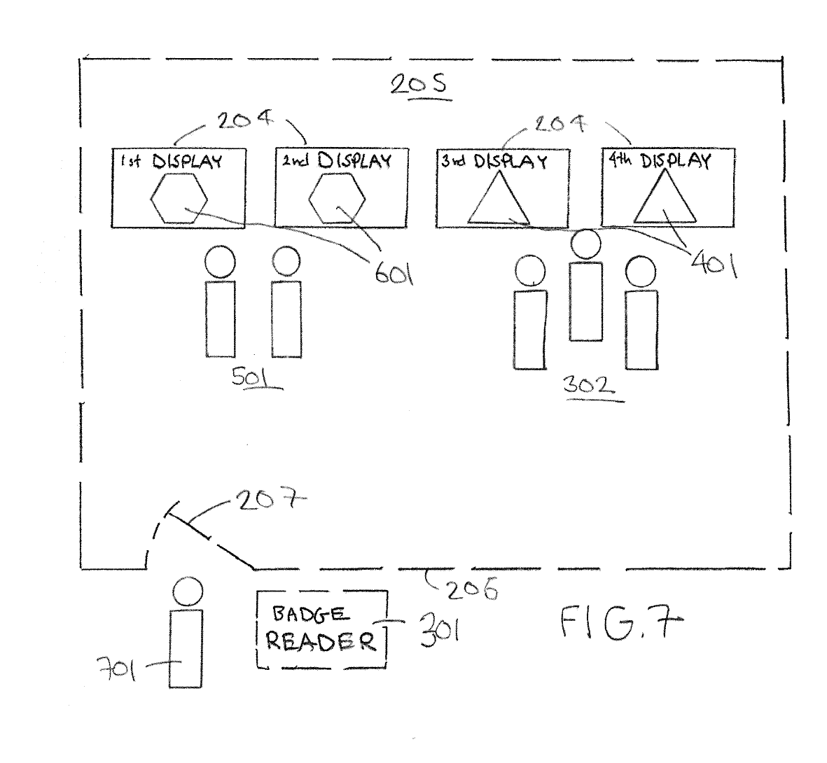

Referring to FIG. 7, as these two groups of executives 302 and 501 interact with their respective presentations 401 and 601, another executive 701 approaches the secured point of entry 207 and presents her badge to the badge reader 301. By one approach, if this executive 701 is not authorized to see one or both of the presentations 401 and 601 presently on display in the presentation zone 205, the control circuit 201 can maintain the secured point of entry 207 in a locked state. If desired, an alert or other notice can be provided in the presentation zone 205 to bring this circumstance to the attention of one or more of the persons present. A user-based decision could be made, for example, to halt the displays and thereby permit the presently unauthorized person 701 to enter.

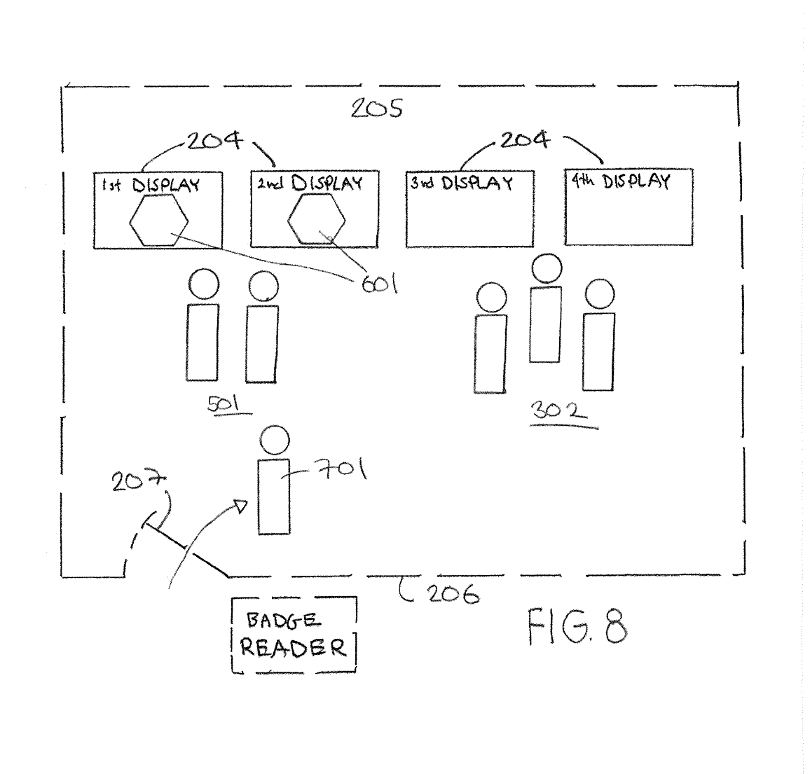

Referring to FIG. 8, by another approach this unauthorized person 701 can be permitted to access the presentation zone 205 notwithstanding their unauthorized status. At the same time, however, the control circuit 201 can automatically halt presentation of any presentation for which this newcomer 701 lacks authorization. In this particular illustrative example, the presentation 401 for the first group of executives 302 is halted but the presentation 601 for the second group of executives 501 remains on display because the newcomer 701 lacks authority to view the first presentation 401 but has sufficient status to view the second presentation 601.

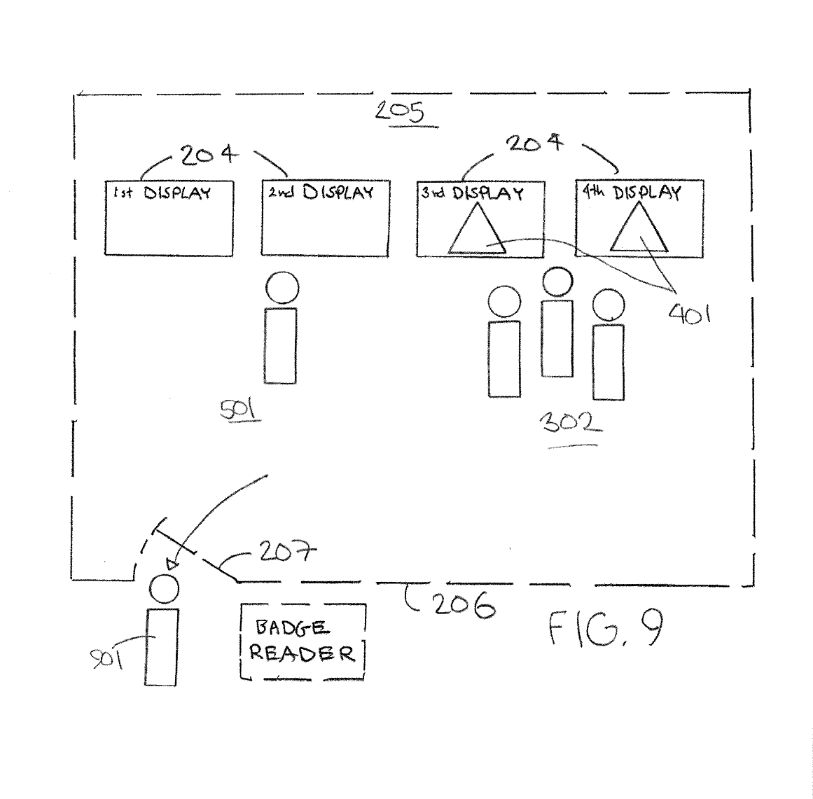

Referring now to FIG. 9, by one approach the control circuit 201 can automatically detect and determine when one of the room inhabitants leaves the room 206. In this example, an executive 901 who is a part of the second group of executives 501 has left the room. In automatic response to this situation the control circuit 201 has responsively halted display of that group's presentation 601. Meanwhile, the presentation 401 for the first group of executives 302 continues without interruption.

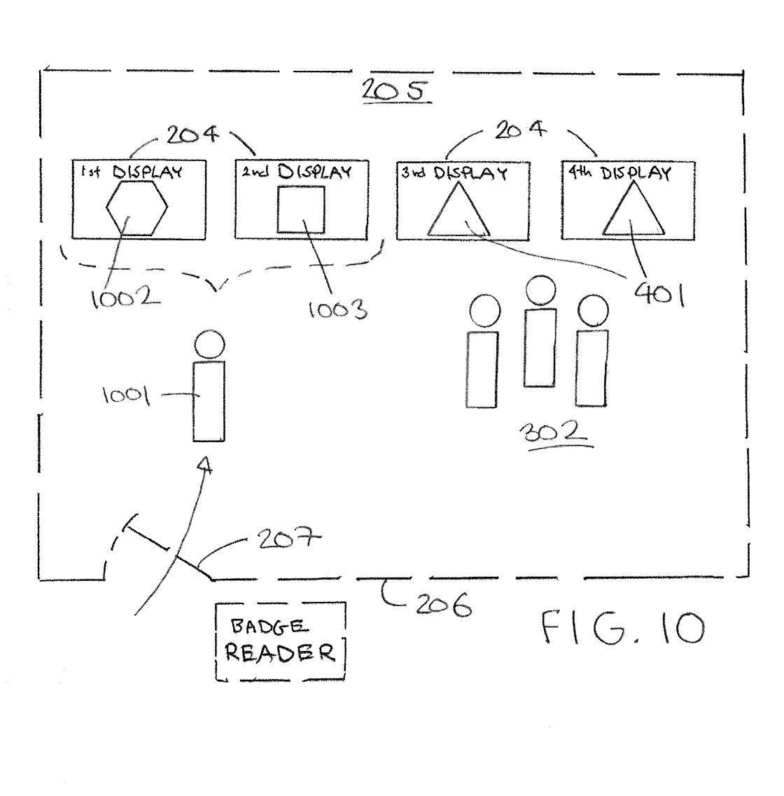

Referring to FIG. 10, in this last example the first group of executives 302 is consuming their respective presentation 401 when another user 1001 enters the room 206. In this case this new room participant 1001 has two different presentations 1002 and 1003 associated with their identity. And in this case the control circuit 201 automatically presents one of those presentations 1002 on the first display and the other of those presentations 1003 on the second display while the other presentation 401 continues as before using the third and fourth displays. Accordingly, two presentations as were previously associated with this particular user 1001 are automatically displayed.

The foregoing examples are not intended to serve as an exhaustive listing of all possible configurations and approaches that might comport with these teachings. Instead, these examples are intended to highlight the great flexibility of these teachings in practical application settings.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept. For example, these teachings will accommodate having users sign in and/or log out. These teachings will also accommodate having the control circuit implement a timeout protocol to, for example, blank the displays in the absence of user activity. By one approach parameters and options in these regards can be set or otherwise accessed by the users of the system when they enter. For example, users can specify how long they expect to use the room, or they can specify a particular timeout duration, or the like.

What is claimed is:

1. An apparatus comprising:
a plurality of displays disposed within a presentation zone;
a user-identification interface;
a memory having a plurality of presentations stored therein; and
a control circuit operably coupled to the plurality of displays and the user-identification interface, the control circuit being configured to:
identify users within the presentation zone;
automatically select, from amongst the plurality of presentations, at least two particular presentations as correspond to two of the users; and
automatically present, at least substantially simultaneously, the at least two particular presentations using the plurality of displays.

2. The apparatus of claim 1 wherein the presentation zone is enclosed within a room.

3. The apparatus of claim 2 wherein the room has a secured point of entry and wherein the user-identification interface is disposed proximal to the secured point of entry.

4. The apparatus of claim 3 wherein the control circuit is further configured to:
control unlocking of the secured point of entry to protect confidentiality of a presentation being presently presented in the presentation zone.

5. The apparatus of claim 1 wherein at least some of the plurality of displays comprise touch-screen displays.

6. The apparatus of claim 1 wherein the presentations include at least one executable statistical analysis.

7. The apparatus of claim 1 wherein the control circuit is further configured to:
determine authorization status for the users within the presentation zone; and
automatically determine to not present at least one of the at least two particular presentations in response to there being a user within the presentation zone who lacks a particular authorization status.

8. The apparatus of claim 1 wherein the control circuit is further configured to:
detect when one of the two users leaves the presentation zone; and
responsively halt presenting the particular presentation as corresponds to the user who left the presentation zone.

10. The apparatus of claim 1 wherein the control circuit is further configured to:
upon identifying a particular user in the presentation zone for whom there are a plurality of corresponding presentations, automatically presenting, at least substantially simultaneously, at least some of the plurality of corresponding presentations using the plurality of displays.

11. The apparatus of claim 1 wherein the control circuit is further configured to:
upon identifying a particular user in the presentation zone for whom there are a plurality of corresponding presentations, automatically providing the particular user with an opportunity to select a particular one of the plurality of corresponding presentations to present via at least one of the plurality of displays.

12. A method comprising:
by a control circuit that operably couples to a user-identification interface, a memory having a plurality of presentations stored therein, and a plurality of displays that are disposed within a presentation zone:
identifying users within the presentation zone;
automatically selecting, from amongst the plurality of presentations, at least two particular presentations as correspond to two of the users; and
automatically presenting, at least substantially simultaneously, the at least two particular presentations using the plurality of displays.

13. The method of claim 12 wherein the presentation zone is enclosed within a room that has a secured point of entry and wherein the user-identification interface is disposed proximal to the secured point of entry.

14. The method of claim 13 further comprising:
controlling unlocking of the secured point of entry to protect confidentiality of a presentation being presently presented in the presentation zone.

15. The method of claim 12 wherein at least some of the plurality of displays comprise touch-screen displays.

16. The method of claim 12 wherein the presentations include at least one executable statistical analysis.

17. The method of claim 12 further comprising:
determining authorization status for the users within the presentation zone; and
automatically determining to not present at least one of the at least two particular presentations in response to there being a user within the presentation zone who lacks a particular authorization status.

18. The method of claim 12 further comprising:
detecting when one of the two users leaves the presentation zone; and
responsively halting presenting the particular presentation as corresponds to the user who left the presentation zone.

19. The method of claim 12 further comprising:
upon identifying a particular user in the presentation zone for whom there are a plurality of corresponding presentations, automatically presenting, at least substantially simultaneously, at least some of the plurality of corresponding presentations using the plurality of displays.

20. The method of claim 12 further comprising:
upon identifying a particular user in the presentation zone for whom there are a plurality of corresponding presentations, automatically providing the particular user with an opportunity to select a particular one of the plurality of corresponding presentations to present via at least one of the plurality of displays.
